(19) United States
(12) Patent Application Publication
(10) Pub. No.: US 2025/0105263 A1
(43) Pub. Date: Mar. 27, 2025

(54) ELECTRODE, METHOD FOR MANUFACTURING ELECTRODE, AND LITHIUM METAL BATTERY COMPRISING ELECTRODE

(71) Applicant: IUCF-HYU (INDUSTRY-UNIVERSITY COOPERATION FOUNDATION HANYANG UNIVERSITY, Seoul (KR)

(72) Inventors: Tae Seup SONG, Seoul (KR); Un Gyu PAIK, Seoul (KR); Chan Ho KIM, Seoul (KR); Jeong Heon KIM, Seoul (KR)

(73) Assignee: IUCF-HYU (INDUSTRY-UNIVERSITY COOPERATION FOUNDATION HANYANG UNIVERSITY, Seoul (KR)

(21) Appl. No.: 18/710,695

(22) PCT Filed: Nov. 15, 2022
(86) PCT No.: PCT/KR2022/017941

§ 371 Date: Dec. 13, 2024

(30) Foreign Application Priority Data
Nov. 19, 2021 (KR) 10-2021-0160324

(51) Int. Cl. H01M 4/36; C01B 25/14; H01M 4/02; H01M 4/48; H01M 10/052

(52) U.S. Cl. CPC H01M 4/366; C01B 25/14; H01M 4/48; H01M 10/052; C01P 2004/03; C01P 2006/40; H01M 2004/027

(57) ABSTRACT

An electrode, a method for manufacturing the electrode, and a lithium metal battery including the electrode are provided. The electrode includes a lithium matrix and a plurality of lithium ion conductive one-dimensional structures dispersed in various directions within the lithium matrix.

### TECHNICAL FIELD

The present invention relates to secondary batteries, and more specifically to lithium metal batteries.

### BACKGROUND ART

Secondary batteries are batteries that can be used repeatedly as they can be recharged as well as discharged. Among secondary batteries, lithium batteries that use lithium ions as an active material, especially lithium-sulfur batteries and lithium-air batteries, can be operated by using lithium metal as a negative electrode. In addition, lithium-ion batteries can also be operated using lithium metal as a negative electrode.

However, when lithium metal is used as a negative electrode in a battery, the growth of lithium dendrites with a high surface area due to unbalanced deposition of lithium causes short circuit of the battery, resulting in low coulombic efficiency, short battery life, and stability problems. In addition, side reactions at the interface between the lithium metal and electrolyte may cause lithium metal surface deterioration and electrolyte reduction, reducing the energy efficiency of the battery. Therefore, industrial use of lithium metal batteries is difficult.

### DISCLOSURE

### Technical Problem

In particular, in the case of an all-solid-state battery using a solid electrolyte, the rate at which lithium is stripped from the interface between the lithium metal and the solid electrolyte into the solid electrolyte during high-power operation is faster than the rate at which lithium is supplied from the lithium metal to the interface, creating voids at the interface. The formation of these voids can reduce the contact area between the solid electrolyte and lithium metal, causing current to be concentrated in the remaining contact area, which can cause lithium dendrites to grow within the solid electrolyte, causing a battery short circuit.

The problem to be solved by the present invention is to provide an electrode that can suppress the generation of voids in the surface of lithium metal and also suppress the generation of lithium dendrites, and a battery including the same.

### Technical Solution

One aspect of the invention provides an electrode. The electrode includes a lithium matrix and a plurality of lithium ion conductive one-dimensional structures dispersed in various directions within the lithium matrix.

The lithium ion conductive one-dimensional structure may include a core that is a lithiophilic metal or an oxide thereof, and a shell that contains an alloy of the lithiophilic metal and lithium. The lithiophilic metal may be Zn, Ti, Si, or Ge, and the oxide of the lithiophilic metal may be ZnO, TiOₓ (1<x≤2), SiOₓ (1<x≤2), GeOₓ (1<x≤2), or LTO (lithium titanium oxide). The core may be an oxide of a lithiophilic metal, and the shell may further contain Li₂O. The lithium ion conductive one-dimensional structure may be a nanorod and may include a ZnO nanorod core and a shell containing LiZn and Li₂O.

Another aspect of the present invention provides a method for manufacturing an electrode. Lithium metal and nanoparticles that are lithiophilic metal or its oxide are mixed at a temperature higher than the melting temperature of the lithium metal, and the mixture is cooled.

The lithium metal and the nanoparticles may have a weight ratio of about 2:8 to 8:2. The nanoparticles may be spherical nanoparticles.

Another aspect of the present invention provides a lithium metal battery. The lithium metal battery includes a negative electrode, a positive electrode including a positive electrode active material, and a liquid or solid electrolyte between the negative electrode and the positive electrode. The negative electrode includes a lithium matrix and a plurality of lithium ion conductive one-dimensional structures dispersed in various directions within the lithium matrix.

The positive electrode active material may be lithium-transition metal oxide or lithium-transition metal phosphate. The electrolyte may be a solid electrolyte. The solid electrolyte may be a sulfide-based solid electrolyte.

### Advantageous Effects

According to the present invention described above, when using an electrode having a plurality of lithium ion conductive one-dimensional structures dispersed in a lithium matrix, void generation and lithium dendrite formation can be efficiently suppressed at the interface between the electrode and the electrolyte during battery operation.

### DESCRIPTION OF DRAWINGS

FIG. 1 is a cross-sectional view showing an electrode according to an embodiment of the present invention.

FIG. 2 is a cross-sectional view schematically showing a lithium metal battery according to an embodiment of the present invention.

FIG. 3 is a schematic diagram showing the interface between a negative electrode and an electrolyte before and after cycle operation of the lithium metal battery according to an embodiment of the present invention.

FIGS. 4a and 4b are scanning electron microscopy (SEM) images of the cross section (a) and top surface (b) of the negative electrode obtained in Negative Electrode Preparation Example 3, respectively.

FIGS. 5a and 5b are TEM images of lithiated ZnO nanorods formed in the negative electrode obtained in Negative Electrode Preparation Example 3.

FIG. 6 is an X-ray diffraction (XRD) graph for lithiated ZnO nanorods formed in the negative electrode obtained in Negative Electrode Preparation Example 3.

FIG. 7 shows electrochemical impedance spectra (EIS) of symmetric cells according to Symmetric Cell Preparation Examples 1 to 3 and Symmetric Cell Comparative Example.

FIGS. 8a, 8b, 8c, 8d, and 8e are, respectively, a plating/stripping voltage profile (a) when the symmetric cells according to Symmetric Cell Preparation Example 3 and Symmetric Cell Comparative Example operate at a stepwise increasing current density, SEM images of the cross-sections of the solid electrolyte layers (b, c), and SEM images of the interface of the electrode/solid electrolyte layer (d, e) after operating the symmetric cells according to Symmetric Cell Preparation Example 3 (c, e) and Symmetric Cell Comparative Example (b, d) at different current densities.

FIGS. 9a, 9b, and 9c are cross-sectional SEM images immediately after preparing the symmetrical cell according to Symmetrical Cell Preparation Example 3 (a), after plating lithium on one electrode of the cell at a current density of 5 mAh·cm⁻² (b), and after plating lithium on the other electrode of the cell at a current density of 5 mAh·cm⁻² (c).

FIG. 10 shows the plating/stripping voltage profiles when the symmetrical cells according to Symmetric Cell Preparation Example 3 and Symmetric Cell Comparative Example operate at a current density of 0.1 mAcm⁻² (a) and 0.5 mAcm⁻² (b).

FIGS. 11a, 11b, 11c, and 11d are the initial charge/discharge voltage profile at 0.05 C (a), discharge capacity at current rates of 0.1, 0.2, 0.5, and 1 C (b), the cycle performance for 100 cycles at 0.1 C (c), and the cycle performance for 100 cycles at 0.3 C (d) of the full cells according to Full Cell Preparation Example and Full Cell Comparative Example. 1C is 1.96 mAcm⁻².

FIGS. 12a, 12c, 12d, and 12g are, respectively, a low-magnification SEM image (a) and a high-magnification SEM image (c) of the cross section, and a high-magnification SEM image of magnifying the inside of the solid electrolyte layer (d) of a full cell using bare lithium metal as a negative electrode (Comparative Example) after being short-circuited, and EIS spectrum before and after cycling of the full cell. FIGS. 12b, 12e, 12f, and 12h are, respectively, a low-magnification SEM image (b) and a high-magnification SEM image (e) of a cross-section, and a high-magnification SEM image magnifying the inside of the solid electrolyte layer (f) of a full cell containing lithiated ZnO nanorods in the negative electrode (Preparation Example) after 100 cycles of operation at 0.3 C, and EIS spectrum before and after cycling of the full cell.

FIGS. 13a and 13b show SEM images taken of the stripped electrodes after charging and discharging the liquid electrolyte cell according to Liquid Electrolyte Cell Preparation Example and Liquid Electrolyte Cell Comparative Example.

### MODES OF THE INVENTION

Since the present invention can be subject to various changes and have various forms, specific embodiments will be illustrated in the drawings and described in detail in the text. However, this is not intended to limit the present invention to a specific disclosed form, and should be understood to include all changes, equivalents, and substitutes included in the spirit and technical scope of the present invention. While describing each drawing, similar reference numerals are used for similar components.

Unless otherwise defined, all terms used herein, including technical or scientific terms, have the same meaning as commonly understood by a person of ordinary skill in the technical field to which the present invention pertains. Terms defined in commonly used dictionaries should be interpreted as having a meaning consistent with the meaning in the context of the related technology, and should not be interpreted in an ideal or excessively formal sense unless explicitly defined in the present application.

In this specification, lithium metal battery refers to all batteries that charge and discharge using lithium metal as a negative electrode, and is not limited to the type of electrolyte. As an example, the electrolyte may be a liquid electrolyte or a solid electrolyte.

Hereinafter, preferred embodiments of the present invention will be described in more detail with reference to the attached drawings.

FIG. 1 is a cross-sectional view showing an electrode according to an embodiment of the present invention.

Referring to FIG. 1, the electrode 20 includes a plurality of lithium ion conductive one-dimensional structures 23 dispersed in a lithium matrix 21.

The one-dimensional structure 23 has a structure with a longer length compared to a width, and may have the form of a nanorod, nanofiber, nanowire, etc., as an example. The width of the one-dimensional structure 23 may be several hundreds of nm, for example, 200 to 800 nm, and the length may be several tens of μm, for example, 10 to 50 μm. The lithium ion conductive one-dimensional structure 23 may include a core made of a lithiophilic metal or an oxide of a lithiophilic metal, and a shell containing an alloy of the lithiophilic metal and lithium.

The lithiophilic metal may be Zn, Ti, Si, Ge, etc., and the oxide of the lithiophilic metal may be ZnO, TiOₓ (1<x≤2), SiOₓ (1<x≤2), GeOₓ (1<x≤2), LTO (lithium titanium oxide), etc. However, it is not limited to this. When the core is the lithiophilic metal such as Zn, Ti, Si, or Ge, the shell may contain LiZn, LiTi, LiSi, or LiGe, respectively. When the core is the oxide of the lithiophilic metal, such as ZnO, TiOₓ (1<x≤2), SiOₓ (1<x≤2), GeOₓ (1<x≤2), the shell may contain LiZn, LiTi, LiSi, or LiGe, respectively, and the shell may further contain Li₂O. When the core is LTO, the shell may contain Li₂O in addition to LiTi. Here, LiZn, LiTi, LiSi, or LiGe may exhibit mixed ion-electron conducting (MIEC) properties having both ionic conductivity and electronic conductivity, and Li₂O may provide a sturdy and stable framework. As an example, the lithium ion conductive one-dimensional structure 23 is a nanorod and may include a ZnO nanorod core and a shell containing LiZn and Li₂O.

The lithium ion conductive one-dimensional structures 23 may be irregularly dispersed within the lithium matrix 21 and have different directions. Additionally, the lithium ion conductive one-dimensional structures 23 may be arranged to cross each other. These lithium ion conductive one-dimensional structures 23 can have high lithium ion conductivity in the longitudinal direction due to the one-dimensional structural characteristics and material characteristics of the lithiophilic metal. As the longitudinal directions of these lithium ion conductive one-dimensional structures 23 are irregularly distributed within the lithium matrix 21, lithium ions can be conducted in various directions from the inside of the lithium matrix 21.

The electrode 20 may be manufactured by mixing lithium metal and nanoparticles that are lithiophilic metals or oxides thereof under temperature conditions equal to or higher than the melting temperature of lithium and then cooling them. The lithium metal and the nanoparticles may be mixed at a weight ratio of about 2:8 to 8:2, specifically 3:7 to 5:5 or 4:6 to 6:4. In one example, the weight of the nanoparticles may be greater than the weight of the lithium metal. The nanoparticles may be spherical particles with a diameter of less than about 100 nm, specifically several tens of nm, for example, 10 to 50 nm. In addition, in the process of mixing equal to or higher than the melting temperature of lithium, the lithiophilic metal on the surface of the nanoparticle may react with lithium to form a lithium alloy (ex. LiZn, LiTi, LiSi, or LiGe), and, in the case that the nanoparticle is the oxide of the lithiophilic metal, lithium can react with oxygen to form Li₂O. Additionally, in the process of mixing equal to or higher than the melting temperature of lithium, the nanoparticles may be changed into a one-dimensional structure to minimize surface energy. Accordingly, as described above, the electrode 20 having the plurality of lithium ion conductive one-dimensional structures 23 dispersed in the lithium matrix 21 can be formed.

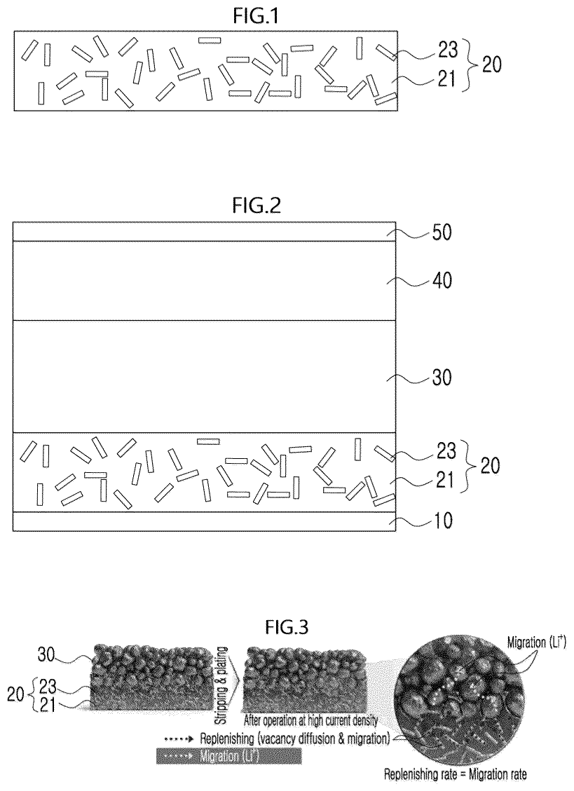

FIG. 2 is a cross-sectional view schematically showing a lithium metal battery according to an embodiment of the present invention.

Referring to FIG. 2, a negative electrode 20 may be provided on a negative electrode current collector 10. Since the negative electrode 20 is the electrode described with reference to FIG. 1, its description will be omitted.

Any material that has high conductivity without causing chemical changes in the lithium secondary battery can be used as the negative electrode current collector 10 without any particular restrictions. As an example, it may be iron, copper, aluminum, nickel, stainless steel, titanium, tantalum, gold, platinum, lithium, etc. The negative electrode current collector 10 may have the form of foil or foam. Specifically, the negative electrode current collector 10 may be copper or stainless steel.

The positive electrode 40 may be disposed on the positive electrode current collector 50.

The positive electrode 40 may contain a positive electrode active material, a conductive material, and a binder. The positive electrode active material may be lithium-transition metal oxide or lithium-transition metal phosphate. The lithium-transition metal oxide may be a complex oxide of lithium and at least one transition metal selected from the group consisting of cobalt, manganese, nickel, and aluminum. Lithium-transition metal oxides include, for example, Li(Ni_{1-x-y}CoₓMn_{y})O₂ (0≤x≤1, 0≤y≤1, 0≤x+y≤1), Li(Ni_{1-x-y}CoₓAl_{y})O₂ (0≤x≤1, 0<y≤1, 0<x+y≤1), or Li(Ni_{1-x-y}CoₓMn_{y})₂O₄ (0≤x≤1, 0≤y≤1, 0≤x+y≤1). The lithium-transition metal phosphate may be a complex phosphate of lithium and at least one transition metal selected from the group consisting of iron, cobalt, and nickel. As an example, the lithium-transition metal phosphate may be Li(Ni_{1-x-y}CoₓFe_{y})PO₄ (0≤x≤1, 0≤y≤1, 0≤x+y≤1). The polymer binder may include, for example, fluororesins such as polyvinylidene fluoride, polytetrafluoroethylene, ethylene tetrafluoride, vinylidene fluoride-based copolymer, and propylene hexafluoride; polyolefin resins such as polyethylene and polypropylene; or cellulose such as carboxymethyl cellulose. The conductive material may be one or more conductive carbon materials selected from the group consisting of carbon black (CB), conducting graphite, ethylene black, and carbon nanotube (CNT).

The positive electrode current collector 50 may be a heat-resistant metal, for example, iron, copper, aluminum, nickel, stainless steel, titanium, tantalum, gold, platinum, etc. In one embodiment, the positive electrode current collector may be aluminum or stainless steel.

The positive electrode 40 and the negative electrode 20 may be disposed to face each other, and an electrolyte 30 may be disposed between them.

The electrolyte 30 may be a solid electrolyte, specifically an oxide-based solid electrolyte, a halide-based solid electrolyte, an oxynitride-based solid electrolyte, or a polymer solid electrolyte. As an example, the solid electrolyte may be a sulfide-based solid electrolyte. The sulfide-based solid electrolyte may be a crystal-based, glass-based, or glass-ceramic type having a thio-LISICON, LGPS, or argyrodite structure. As an example, the solid electrolyte having a thio-LISICON crystal structure may be Li₃PS₄, the solid electrolyte having an LGPS crystal structure may be Li₁₀GeP₂S₁₂, and the solid electrolyte having an argyrodite crystal structure may be Li₆PS₅X (X=Cl, Br, I). The glass-ceramic solid electrolyte may be xLi₂S·(100-x)P₂S₅ (x is 60 to 90). When the electrolyte 30 is a solid electrolyte, the positive electrode 40 may further include the solid electrolyte particles in addition to the positive electrode active material, the conductive material, and the binder.

In another example, the electrolyte 30 may be a liquid electrolyte impregnated within a separator. The liquid electrolyte may be a non-aqueous electrolyte solution. The non-aqueous electrolyte solution may include an electrolyte that is a lithium salt and an organic solvent. Lithium salts may include lithium perchlorate (LiClO₄), lithium tetrafluoroborate (LiBF₄), lithium hexafluorophosphate (LiPF₆), lithium trifluoromethane selfonate (LiCF₃SO₃), lithium hexafluoroarsenate (LiAsF₆), or lithium trifluoromethanesulfonylimide (LiTFSi, Li(CF₃SO₂)₂N). The organic solvent may be carbonate-based, sulfone-based, ether-based, or a combination thereof. The carbonate-based solvent may include ethylene carbonate, propylene carbonate, dimethyl carbonate, methyl ethyl carbonate, diethyl carbonate, fluoroethylene carbonate, or a combination of two or more thereof. The sulfone-based solvent may include dipropyl sulfone, dibutyl sulfone, dimethoxy sulfone, diethoxy sulfone, methoxy propyl sulfone, phenyl propyl sulfone, or a combination of two or more thereof. The ether-based solvent may be a cyclic ether and/or a linear ether. The cyclic ether may be dioxolane, dioxane, or tetrahydrofuran. The linear ether may be a dialkyl ether and/or a polyalkyleneglycol dialkylether. Examples of the dialkyl ether include di(C1-C4) alkyl ether, and may include dimethyl ether and dibutyl ether. The polyalkylene glycol dialkylether may be DME (dimethoxyethane), tetraethyleneglycol dimethylether (TEGDME), triethyleneglycol dimethylether (TEGDME), or diethyleneglycol dimethylether (DEGDME). As an example, the solvent may be a combination of dialkyl ether and polyalkyleneglycol dialkylether. The separator separates the positive electrode 20 and the negative electrode 40 and provides a passage for lithium ions, and can be used without particular restrictions as long as it is normally used as a separator in a lithium secondary battery. In particular, it is desirable to have low resistance to ion movement in the electrolyte and excellent electrolyte wettability. For example, it may include polyethylene, polypropylene, or a co-polymer of polyethylene and polypropylene, and a multilayer film of two or more layers thereof may be used.

FIG. 3 is a schematic diagram showing the interface between the negative electrode and the electrolyte before and after cycle operation of the lithium metal battery according to an embodiment of the present invention.

Referring to FIG. 3, when the battery operates, for example when discharge occurs, lithium ions are stripped from the negative electrode 20, especially from the surface of the negative electrode 20. During this process, the lithium ion conductive one-dimensional structure 23 may provide an efficient transport path for lithium ions; and therefore, lithium ions can be transported from the entire lithium matrix 21 to the interface between the negative electrode 20 and the electrolyte 30 to replenish the lithium on the negative electrode surface. Accordingly, the formation of voids that may form due to partial lithium stripping on the surface of the negative electrode may be suppressed, and the current density at the interface between the negative electrode 20 and the electrolyte 30 can be evenly distributed, thereby suppressing lithium dendrite formation due to the local current density elevation. The efficient transport of lithium ions in this lithium ion conductive one-dimensional structure 23 can greatly suppress the formation of voids on the negative electrode surface and the formation of lithium dendrites on the upper part of the negative electrode, which are particularly prone to be formed when the battery operates at high speed.

The electrolyte may be a solid electrolyte. In this case, a material forming the negative electrode may be introduced between the solid electrolyte particles at the interface between the negative electrode 20 and the solid electrolyte 30 by pressure applied during battery manufacturing. In addition, since the solid electrolyte 30 has a limited contact area with the negative electrode 20 compared to the liquid electrolyte that permeates into the negative electrode, there is a high probability that the voids described above will be created, and accordingly, the probability of lithium dendrites growing into the solid electrolyte 30 is high. However, when using the negative electrode 20 having a plurality of lithium ion conductive one-dimensional structures 23 dispersed in the lithium matrix 21 as in this embodiment, void generation and lithium dendrite formation can be efficiently suppressed.

Hereinafter, a preferred experimental example is presented to help understanding of the present invention. However, the following experimental examples are only to aid the understanding of the present invention, and the present invention is not limited by the following experimental examples.

### Negative Electrode Preparation Example 1

After preheating a SUS crucible to 250° C. in a glove box filled with argon, lithium metal and ZnO nanoparticles (Sigma-Aldrich, nanopowder, more than 90% of which have a particle size of less than 50 nm) were added to the SUS crucible at a weight ratio of 8:2. After mixing by vigorous stirring for 5 minutes, the crucible was cooled to room temperature, and the resulting product was roll pressed to form a negative electrode with a thickness of 200 μm.

### Negative Electrode Preparation Example 2

A negative electrode was formed using the same method as Negative Electrode Preparation Example 1, except that lithium metal and ZnO nanoparticles were added at a weight ratio of 6:4.

### Negative Electrode Preparation Example 3

A negative electrode was formed using the same method as Negative Electrode Preparation Example 1, except that lithium metal and ZnO nanoparticles were added at a weight ratio of 4:6.

### Solid Electrolyte Preparation Example

Li₂S (Sigma-Aldrich, 99.98%), P₂S₅ (Sigma-Aldrich, 99.9%), and LiCl (Sigma-Aldrich, 99%) with a molar ratio of 5:1:2 were mixed by ball milling using a planetary ball mill (Pulverisette 7, Fritsch) at 500 rpm for 10 hours. Afterwards, the mixture was heated at 550° C. for 5 hours at a ramping rate of 2° C. to obtain Li₆PS₅Cl powder with argyrodite phase. Li₆PS₅Cl powder contained particles of approximately 1 to 5 μm and exhibited a conductivity of 1.4×10⁻³ Scm⁻¹.

### Symmetric Cell Preparation Example 1

In a dry glove box filled with argon, the solid electrolyte obtained from the Solid Electrolyte Preparation Example was placed in a polycarbonate tube and compressed to 300 MPa to form a solid electrolyte layer. The negative electrodes obtained in Negative Electrode Preparation Example 1 were placed on both sides of the solid electrolyte layer and pressed at 40 MPa to attach the upper and lower negative electrodes to the solid electrolyte layer to prepare a symmetrical cell.

### Symmetric Cell Preparation Example 2

A symmetrical cell was prepared using the same method as Symmetric Cell Preparation Example 1, except that the negative electrodes obtained in Negative Electrode Preparation Example 2 were used instead of the negative electrodes obtained in Negative Electrode Preparation Example 1.

### Symmetric Cell Preparation Example 3

A symmetrical cell was prepared using the same method as Symmetric Cell

Preparation Example 1, except that the negative electrodes obtained in Negative Electrode Preparation Example 3 were used instead of the negative electrodes obtained in Negative Electrode Preparation Example 1.

### Symmetric Cell Comparative Example

A symmetrical battery was prepared using the same method as Symmetric Cell Preparation Example 1, except that lithium metal layers were used instead of the negative electrodes obtained in Negative Electrode Preparation Example 1.

### Full Cell Preparation Example

LiNbO₃-coated Li(Ni_{0.8}Mn_{0.1}Co_{0.1})O₂, Li₆PS₅Cl powder obtained from the Solid Electrolyte Preparation Example, carbon nanofibers, and polytetrafluoroethylene (Sigma-Aldrich, average particle size 20 microns) were mixed at a weight ratio of 75:22:2:1 to obtain positive electrode active material mixture.

Li₆PS₅Cl powder obtained from the Solid Electrolyte Preparation Example was placed in a polycarbonate tube and compressed at 50 MPa to form a solid electrolyte layer.

The positive electrode active material mixture was spread on the upper surface of the solid electrolyte layer and then pressed at 300 MPa to form a positive electrode. The negative electrode obtained in Negative Electrode Preparation Example 3 was placed on the lower surface of the solid electrolyte layer and pressed at less than 50 MPa to attach the negative electrode to the solid electrolyte layer.

### Full Cell Comparative Example

A full cell was prepared using the same method as the Full Cell Preparation

Example, except that a lithium metal layer was used instead of the negative electrode obtained in Negative Electrode Preparation Example 3.

### Liquid Electrolyte Cell Preparation Example

A liquid electrolyte was prepared by dissolving LiPF₆ at a concentration of 1.3M and FEC (fluoroethylene carbonate) at 5 wt % in EC (ethylene carbonate): DMC (dimethyl carbonate) (3:7, v:v). A liquid electrolyte symmetric cell was prepared by introducing the liquid electrolyte between the electrodes obtained in Negative Electrode Preparation Example 3.

### Liquid Electrolyte Cell Comparative Example

A liquid electrolyte cell was prepared using the same method as Liquid Electrolyte Cell Preparation Example, except that a liquid electrolyte was introduced between the lithium metal layers instead of the electrodes obtained in Negative Electrode Preparation Example 3.

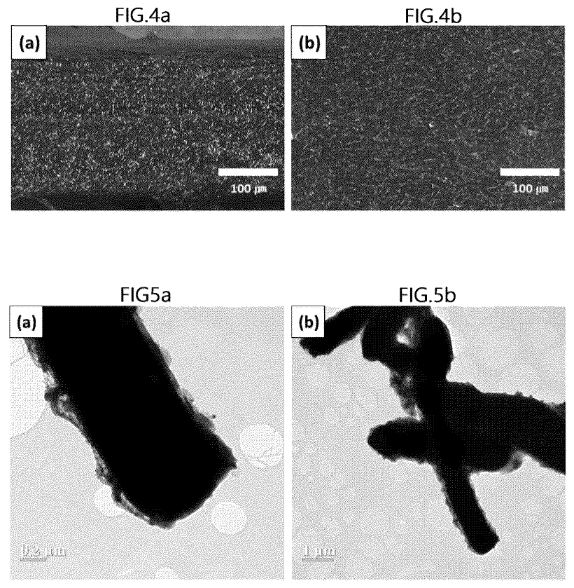

FIGS. 4a and 4b are scanning electron microscopy (SEM) images of the cross section (a) and top surface (b) of the negative electrode obtained in Negative Electrode Preparation Example 3, respectively.

Referring to FIGS. 4a and 4b, it can be seen that lithiated ZnO nanorods are uniformly dispersed within the Li metal matrix.

FIGS. 5a and 5b are TEM images of lithiated ZnO nanorods formed in the negative electrode obtained in Negative Electrode Preparation Example 3.

Referring to FIGS. 5a and 5b, it can be seen that the lithiated ZnO nanorod has a diameter of about 500 nm and a length of about 20 μm.

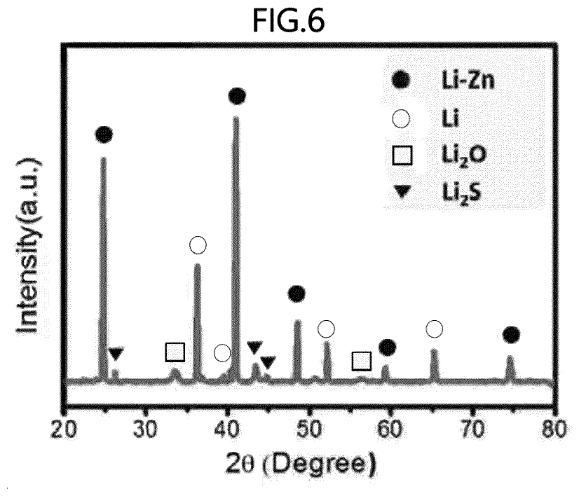

FIG. 6 is an X-ray diffraction (XRD) graph for lithiated ZnO nanorods formed in the negative electrode obtained in Negative Electrode Preparation Example 3.

Referring to FIG. 6, crystal phases of Li-Zn alloy, Li₂O, and Li were detected from the surface of the lithiated ZnO nanorod. It was understood that the weak LizS peak was generated as the negative electrode was manufactured in the glove box in which the solid electrolyte layer preparation example was performed.

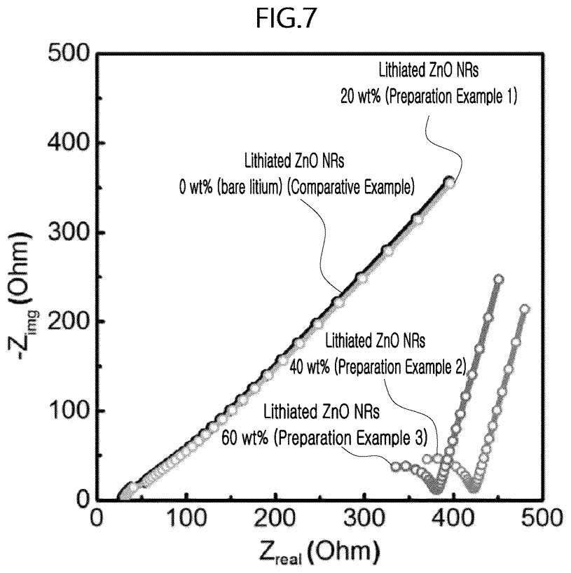

FIG. 7 shows electrochemical impedance spectra (EIS) of symmetric cells according to Symmetric Cell Preparation Examples 1 to 3 and Symmetric Cell Comparative Example.

Referring to FIG. 7, in the case of the symmetric cell having a lithium metal/solid electrolyte (SE) layer/lithium metal obtained from Symmetric Cell Comparative Example and the symmetric cell having a lithium layer containing 20 wt % ZnO/SE layer/lithium layer containing 20 wt % ZnO obtained from Symmetric Cell Preparation Example 1, a typical Nyquist plot corresponding to a capacitor is shown. Since this corresponds to the observation of capacitance due to a double charge layer at the interface between the SE layer and the electrode, it can be seen that the lithium layer containing 20 wt % or less of ZnO hardly provides a lithium ion conduction path.

Meanwhile, the symmetric cell having a lithium layer containing 40 wt % ZnO obtained from Symmetric Cell Preparation Example 2 and the symmetric cell having a lithium layer containing 60 wt % ZnO obtained from Symmetric Cell Preparation

Example 3 show the Nyquist plot of a typical ion conductor. Therefore, it can be seen that the lithiated ZnO nanorods in the lithium layer containing 40 wt % or more of ZnO effectively act as lithium ion conductors. In addition, it can be seen that the lithium ion conductivity was further improved in the lithium layer containing 60 wt % ZnO compared to the lithium layer containing 40 wt % ZnO.

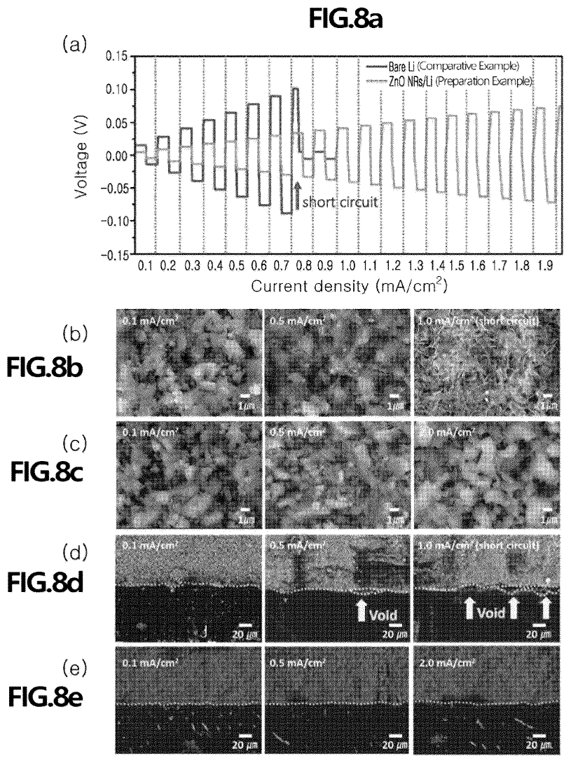

FIGS. 8a, 8b, 8c, 8d, and 8e are, respectively, a plating/stripping voltage profile (a) when the symmetric cells according to Symmetric Cell Preparation Example 3 and Symmetric Cell Comparative Example operate at a stepwise increasing current density, SEM images of the cross-sections of the solid electrolyte layers (b, c), and SEM images of the interface of the electrode/solid electrolyte layer (d, e) after operating the symmetric cells according to Symmetric Cell Preparation Example 3 (c, e) and Symmetric Cell Comparative Example (b, d) at different current densities.

Referring to FIG. 8a, when the symmetric cells is operated at a current density that gradually increases by 0.1 mAcm⁻² at a fixed capacity of 0.1 mAhcm⁻², the symmetrical cell (Preparation Example 3) using an electrode in which lithiated ZnO nanorods are dispersed in a Li matrix exhibits a much lower overpotential compared to the symmetrical cell (Comparative Example) using bare lithium metal as an electrode and exhibits stable operation without short circuit even at a high current density of 2.0 mAcm⁻². This shows that Li ions can rapidly move through lithiated ZnO nanorods.

Referring to FIGS. 8b and 8c, it can be seen that dendritic Li has grown in the solid electrolyte layer after the symmetrical cell (Comparative Example) using bare lithium metal as an electrode was operated at a current density of 0.5mAcm⁻², and dendritic Li appears more clearly after operated at a current density of 1mAcm⁻² (b). From this, it can be understood that the reason that the symmetrical cell according to Symmetric Cell Comparative Example no longer operates after operating at a current density of 1 mAcm⁻² as shown in (a) is due to Li dendrites grown in the solid electrolyte layer (b). On the other hand, in the symmetrical cell (Preparation Example 3) using an electrode in which lithiated ZnO nanorods were dispersed in a Li matrix, dendritic Li was not observed in the solid electrolyte layer after operating at a current density of 0.5 mAcm⁻², but some dendritic Li was observed in the solid electrolyte layer after operating at a current density of 2.0 mAcm⁻² (c).

Referring to FIGS. 8d and 8e, it was confirmed that a void was formed at the interface of the electrode/solid electrolyte layer after operating symmetrical cell (Comparative Example) using bare lithium metal as an electrode at a current density of 0.5 mAcm⁻², and this void became wider after operating at 1.0 mAcm⁻² (d). On the other hand, the symmetric cell (Preparation Example 3) using an electrode in which lithiated ZnO nanorods were dispersed in a Li matrix showed an excellent interface contact with no voids created at the interface of the electrode/solid electrolyte layer even after operation at a high current density of 2 mAcm⁻² (e).

As a result, it can be seen that lithium ion conduction is improved by lithiated ZnO nanorods, which enables stable operation of the battery at a fairly high current density.

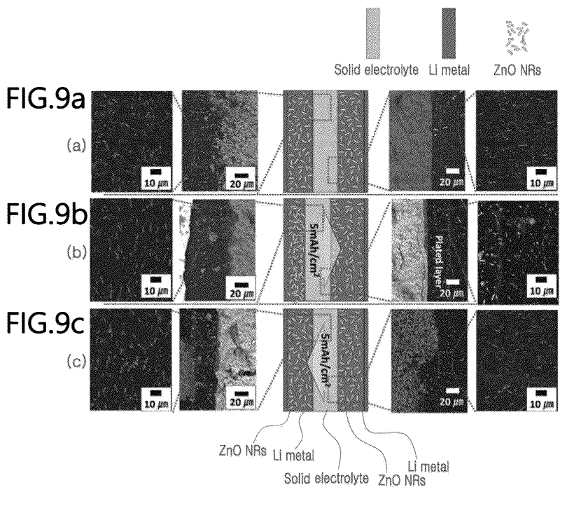

FIGS. 9a, 9b, and 9c are cross-sectional SEM images immediately after preparing the symmetrical cell according to Symmetrical Cell Preparation Example 3 (a), after plating lithium on one electrode of the cell at a current density of 5 mAh·cm⁻² (b), and after plating lithium on the other electrode of the cell at a current density of 5 mAh·cm⁻² (c).

Referring to FIGS. 9a, 9b, and 9c, immediately after preparing the symmetrical cell, both electrodes had the same thickness (a). After plating lithium on the right electrode at a current density of 5 mAh·cm⁻², the thickness of the right electrode increased (b). Then, after plating lithium on the left electrode at a current density of 5 mAh·cm⁻², the right and left electrodes changed back to almost the same thickness.

After plating lithium to the right electrode at a current density of 5 mAh cm⁻² (b), ZnO nanorods are distributed homogeneously, as in other parts, within the newly created lithium layer (plated layer) with a thickness of approximately 25 μm on the right electrode. It can be understood that due to the lithiated ZnO nanorods, lithium ions diffused into the electrode and then were reduced to lithium rather than reduced to lithium at the interface with the solid electrolyte layer. In addition, it can be seen that ZnO nanorods are homogeneously distributed within the left electrode. This can also be understood as stripping of Li from the left electrode occurred throughout the entire electrode.

Therefore, it can be understood that the movement of Li is not limited to the surface of the electrode having a lithium matrix in which lithiated ZnO nanorods are dispersed, but occurs throughout the entire electrode. Additionally, this was understood to mean that lithiated ZnO nanorods perform an excellent role as lithium ion conductors.

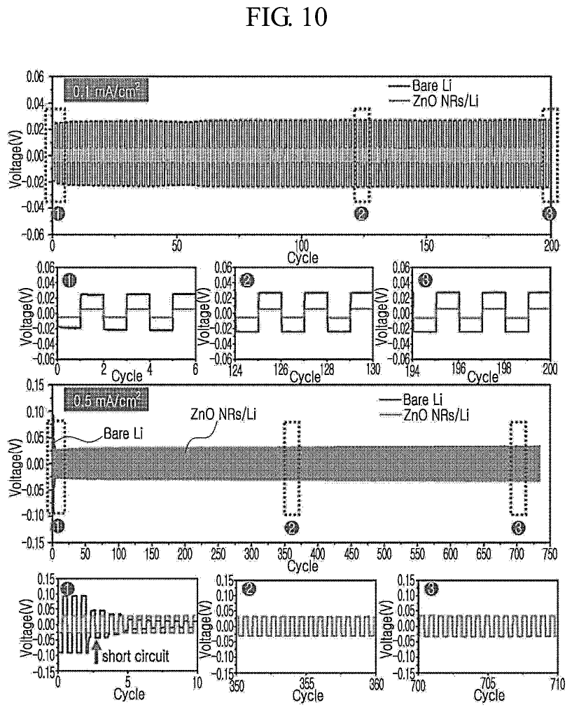

FIG. 10 shows the plating/stripping voltage profiles when the symmetrical cells according to Symmetric Cell Preparation Example 3 and Symmetric Cell Comparative Example operate at a current density of 0.1 mAcm⁻² (a) and 0.5 mAcm⁻² (b).

Referring to FIG. 10, compared to the symmetric cell having bare lithium metal as an electrode (Comparative Example), the symmetric cell having an electrode in which lithiated ZnO nanorods are dispersed in a lithium matrix (Preparation Example 3) not only shows a low overpotential, but also shows stable operation after 700 cycles even at a high current density of 0.5mAcm⁻². As such, the symmetric cell having an electrode in which lithiated ZnO nanorods are dispersed in a lithium matrix (Preparation Example 3) has excellent electrochemical stability, which is due to the improved lithium replenishment rate resulting from the lithiated ZnO nanorods.

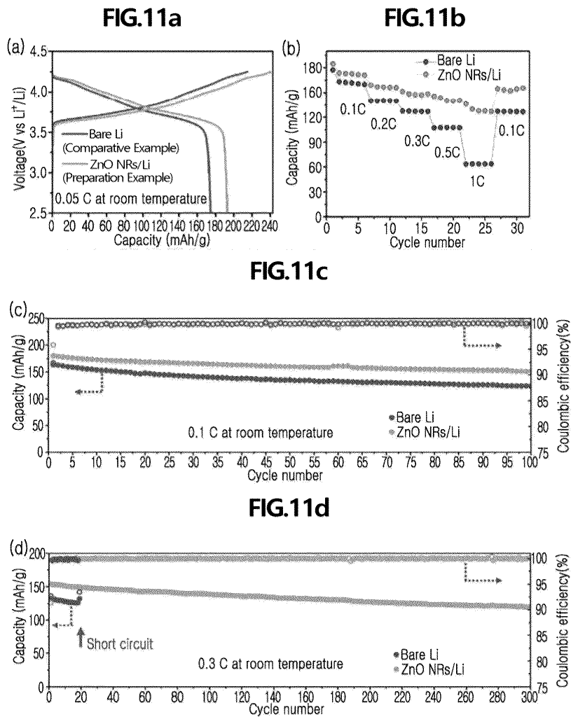

FIGS. 11a, 11b, 11c, and 11d are the initial charge/discharge voltage profile at 0.05 C (a), discharge capacity at current rates of 0.1, 0.2, 0.5, and 1 C (b), the cycle performance for 100 cycles at 0.1 C (c), and the cycle performance for 100 cycles at 0.3 C (d) of the full cells according to Full Cell Preparation Example and Full Cell Comparative Example. 1C is 1.96 mAcm⁻².

Referring to FIG. 11a, the full cell containing lithiated ZnO nanorods in the negative electrode (Preparation Example) shows a specific discharge capacity of 184.12 mAhg⁻¹ (initial coulombic efficiency=81.1%), which is better than the specific discharge capacity of 174.46 mAhg⁻¹ (initial coulombic efficiency=81.2%) of the full cell using bare lithium metal as the negative electrode (Comparative Example).

Referring to FIG. 11b showing the rate characteristics, the full cell containing lithiated ZnO nanorods in the negative electrode (Preparation Example) shows the average charge capacities of 172.41, 156.95, 148.52, 142.13, and 129.77 mAhg⁻¹ at 0.1, 0.2, 0.3, 0.5, and 1C, respectively, which are much improved speed capabilities compared to the average charge capacities of 161.54, 140.18, 127.25, 107.55, and 63.64 mAhg⁻¹ at 0.1, 0.2, 0.3, 0.5, and 1C, respectively, of the full cell using bare lithium metal as the negative electrode (Comparative Example). These results indicate that the interfacial resistance of the negative electrode/solid electrolyte interface plays an important role in the rate performance, and the improved lithium ion migration between the negative electrode and the solid electrolyte layer due to the improved Li replenishment rate by introducing lithiated ZnO nanorods in Li metal enables significant improvements in rate properties.

Referring to FIGS. 11c and 11d showing the cycle characteristics at 0.1 C and 0.3 C, the full cell containing lithiated ZnO nanorods in the negative electrode (Preparation Example) and the full cell using bare lithium metal as the negative electrode (Comparative Example) show capacity retention rates of 83.5% and 75.8% after 100 cycles at 0.1 C, respectively. At 0.3C operation, the full cell using bare lithium metal as the negative electrode (Comparative Example) short-circuited after the 20th cycle of operation, while the full cell containing lithiated ZnO nanorods in the negative electrode (Preparation Example) shows stable cycle performance with a capacity retention rate of 94.0% the the 50th cycle, 89.9% at the 100th cycle, 82.6% at the 200th cycle, and 77.8% at the 300th cycle.

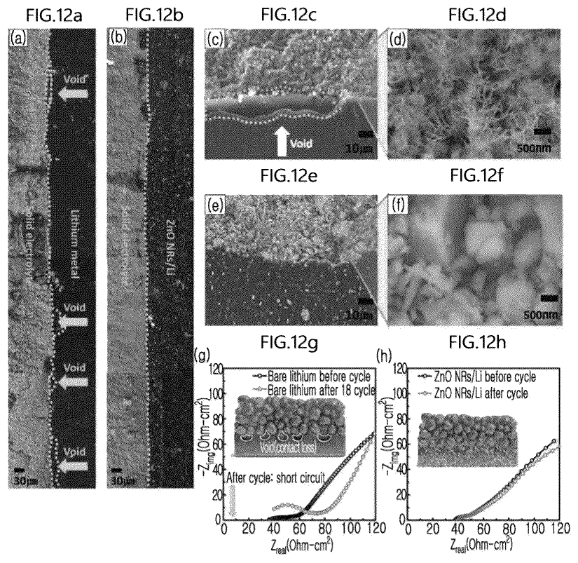

FIGS. 12a, 12c, 12d, and 12g are, respectively, a low-magnification SEM image (a) and a high-magnification SEM image (c) of the cross section, and a high-magnification SEM image of magnifying the inside of the solid electrolyte layer (d) of a full cell using bare lithium metal as a negative electrode (Comparative Example) after being short-circuited, and EIS spectrum before and after cycling of the full cell. FIGS. 12b, 12e, 12f, and 12h are, respectively, a low-magnification SEM image (b) and a high-magnification SEM image (e) of a cross-section, and a high-magnification SEM image magnifying the inside of the solid electrolyte layer (f) of a full cell containing lithiated ZnO nanorods in the negative electrode (Preparation Example) after 100 cycles of operation at 0.3 C, and EIS spectrum before and after cycling of the full cell.

Referring to FIGS. 12a, 12c, and 12d, when a full cell using bare lithium metal as the negative electrode (Comparative Example) is short-circuited after operating for 20 cycles at 0.3 C, it was confirmed that the contact area between the negative electrode and the solid electrolytes was significantly reduced due to the large void formed over a wide area at the interface between the negative electrode and the solid electrolyte. This poor contact increases the interfacial resistance and local current density, making it easier for Li dendrites to form and grow. A high-magnification SEM image of the solid electrolyte layer near the interface between the negative electrode and the solid electrolyte shows severe dendrite formation.

Referring to FIGS. 12b, 12e, and 12f, a full cell containing lithiated ZnO nanorods in the negative electrode (Preparation Example) shows excellent interfacial contact without the formation of noticeable voids even after operating for 100 cycles at a rate of 0.3 C (b, e). Additionally, a high-magnification SEM image of the solid electrolyte layer near the interface between the negative electrode and the solid electrolyte shows that no Li dendrites are generated at all (f). It was understood that lithiated ZnO nanorods can increase the rate of Li replenishment from the inside of the Li matrix to the negative electrode/solid electrolyte interface, thereby suppressing the formation of voids at the negative electrode/solid electrolyte interface and suppressing the formation of dendrites in the solid electrolyte layer.

Referring to FIGS. 12g and 12h showing the EIS analysis results, the full cell using bae lithium metal as the negative electrode (Comparative Example) had a Rreal value of 62 ohm·cm², but after 18 cycles of operation, it increased to 72 ohm·cm² and a short circuit occurred (g). This was understood to be caused by an increase in contact resistance due to the accumulation of voids and dendrites propagated by the increased local current density during operation, resulting in a short circuit. On the other hand, a full cell containing lithiated ZnO nanorods in the negative electrode (Preparation Example) showed a Rreal value of 63 ohm·cm² after cycling, a similar value to that before operation.

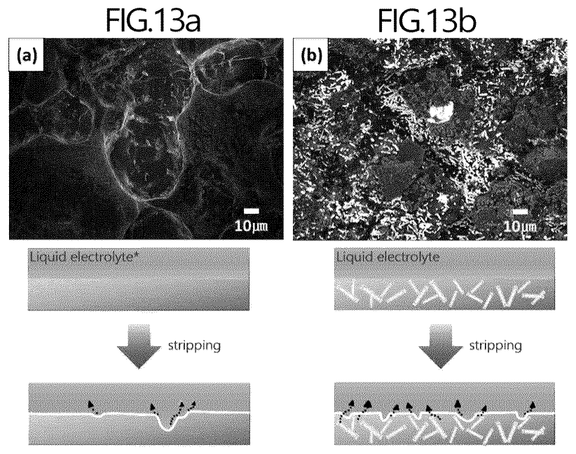

FIGS. 13a and 13b show SEM images taken of the stripped electrodes after charging and discharging the liquid electrolyte cell according to Liquid Electrolyte Cell Preparation Example and Liquid Electrolyte Cell Comparative Example.

Referring to FIGS. 13a and 13b, it can be seen that in the case of a battery using lithium metal foil (Comparative Example), lithium was mainly released from a specific area of the surface, forming a large pit (a). On the other hand, in the battery (Preparation Example) containing lithiated ZnO nanorods in the electrode, it can be seen that lithium is uniformly released from around the lithiated ZnO nanorods (b). This indicates that lithiated ZnO nanorods allow uniform Li stripping from the lithium matrix.

While the exemplary embodiments of the present invention have been described above, those of ordinary skill in the art should understood that various changes, substitutions and alterations may be made herein without departing from the spirit and scope of the present invention as defined by the following claims.

1. An electrode comprising:
a lithium matrix; and
a plurality of lithium ion conductive one-dimensional structures dispersed in various directions within the lithium matrix.

2. The electrode of claim 1, wherein the lithium ion conductive one-dimensional structure includes a core that is a lithiophilic metal or an oxide of a lithiophilic metal, and a shell that contains an alloy of the lithiophilic metal and lithium.

3. The electrode of claim 2, wherein the lithiophilic metal is Zn, Ti, Si, or Ge, and the oxide of the lithiophilic metal is ZnO, TiOₓ (1<x≤2), SiOₓ (1<x≤2), GeOₓ (1<x≤2), or LTO (lithium titanium oxide).

4. The electrode of claim 2, wherein the core is the oxide of the lithiophilic metal, and the shell further contains Li₂O.

5. The electrode of claim 1, wherein the lithium ion conductive one-dimensional structure is a nanorod and includes a ZnO nanorod core and a shell containing LiZn and Li₂O.

6. A method for manufacturing the electrode of claim 1 comprising:
mixing lithium metal and nanoparticles that are lithiophilic metal or lithiophilic metal oxide at a temperature higher than the melting temperature of the lithium metal;
and cooling the mixture.

7. The method of claim 6, wherein the lithium metal and the nanoparticles have a weight ratio of about 2:8 to 8:2.

8. The electrode of claim 6, wherein the nanoparticles are spherical nanoparticles.

9. A lithium metal battery comprising:
a negative electrode including a lithium matrix and a plurality of lithium ion conductive one-dimensional structures dispersed in various directions within the lithium matrix;
a positive electrode including a positive electrode active material; and
a liquid or solid electrolyte between the negative electrode and the positive electrode.

10. The lithium metal battery of claim 9, wherein the lithium ion conductive one-dimensional structure includes a core that is a lithiophilic metal or an oxide of a lithiophilic metal, and a shell that contains an alloy of the lithiophilic metal and lithium.

11. The lithium metal battery of claim 10, wherein the lithiophilic metal is Zn, Ti, Si, or Ge, and the oxide of the lithiophilic metal is ZnO, TiOₓ (1<x≤2), SiOₓ (1<x≤2), GeOₓ (1<x≤ 2), or LTO (lithium titanium oxide).

12. The lithium metal battery of claim 10, wherein the core is the oxide of the lithiophilic metal, and the shell further contains Li₂O.

13. The lithium metal battery of claim 9, wherein the lithium ion conductive one-dimensional structure is a nanorod and includes a ZnO nanorod core and a shell containing LiZn and Li₂O.

14. The lithium metal battery of claim 9, wherein the positive electrode active material is lithium-transition metal oxide or lithium-transition metal phosphate.

15. The lithium metal battery of claim 9, wherein the electrolyte is a solid electrolyte.

16. The lithium metal battery of claim 15, wherein the solid electrolyte is a sulfide-based solid electrolyte, an oxide-based solid electrolyte, a halide-based solid electrolyte, an oxynitride-based solid electrolyte, or a polymer solid electrolyte.
